(19) United States
(12) Patent Application Publication
(10) Pub. No.: US 2008/0027767 A1
(43) Pub. Date: Jan. 31, 2008

(54) Method and system for customization of air travel

(76) Inventors: Gerald B. Gunn, Vancouver (CA); Charles D. McKee, Toronto (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/788,374

(22) Filed: Apr. 18, 2007

Related U.S. Application Data
(60) Provisional application No. 60/820,575, filed on Jul. 27, 2006.

(51) Int. Cl. G06Q 10/00

(52) U.S. Cl. 705/5

(57) ABSTRACT

Method, architecture and computer-readable medium to enable a user of a computer-implemented graphical user interface (GUI) to purchase air travel services. The method comprises receiving air travel parameters submitted via the GUI; receiving a selection made via the GUI, the selection being indicative of at least one selected service attribute from a service attribute set; determining a core price for a flight meeting said air travel parameters; determining at least one price differential associated with the at least one selected service attribute; determining a purchase price based on the core price and the at least one price differential; causing the purchase price to be displayed via the GUI; and causing said flight to be booked in response to receipt of a confirmation made via the GUI of an intent to purchase a ticket for said flight at the purchase price.

### CROSS-REFERENCE TO RELATED APPLICATION

This application claims the benefit under 35 U.S.C. 119(e) of U.S. Provisional Patent Application Ser. No. 60/820,575, filed on Jul. 27, 2006, hereby incorporated by reference herein.

### FIELD OF THE INVENTION

The present invention relates generally to customization of air travel and, more particularly, to methods and systems for enabling a user of a computer-implemented graphical user interface to purchase customized air travel services.

### BACKGROUND

Air travel is typically booked by purchasing a ticket for a flight at one of several service levels. Each service level is associated with a fixed set of available service attributes and has a price that differs accordingly. Thus, passengers desiring certain service attributes that are only available at a higher service level than the one initially considered have only one option, namely to book the flight at the higher service level and pay the associated price, which is correspondingly higher.

This is a drawback when the passenger may desire only a limited subset of the service attributes exclusively available at the higher service level. In addition, passengers who do not purchase a ticket at the higher service level due to the price barrier and end up settling for an inferior array of service attributes represent a lost revenue opportunity for providers of air travel services, notably airlines.

### SUMMARY OF THE INVENTION

According to a first broad aspect, the present invention seeks to provide a method to enable a user of a computer-implemented graphical user interface (GUI) to purchase air travel services, comprising:
receiving air travel parameters submitted via the GUI;
receiving a selection made via the GUI, the selection being indicative of at least one selected service attribute from a service attribute set;
determining a core price for a flight meeting said air travel parameters;
determining at least one price differential associated with the at least one selected service attribute;
determining a purchase price based on the core price and the at least one price differential;
causing the purchase price to be displayed via the GUI; and
causing said flight to be booked in response to receipt of a confirmation made via the GUI of an intent to purchase a ticket for said flight at the purchase price.

According to a second broad aspect, the present invention seeks to provide a computer-readable medium comprising computer-readable program code which, when interpreted by a computing apparatus, causes the computing apparatus to execute a method to enable a user of a computer-implemented graphical user interface (GUI) to purchase air travel services, the computer-readable program code comprising:
first computer-readable program code for causing the computing apparatus to be attentive to receipt of air travel parameters submitted via the GUI;
second computer-readable program code for causing the computing apparatus to be attentive to receipt of a selection made via the GUI, the selection being indicative of at least one selected service attribute from a service attribute set;
third computer-readable program code for causing the computing apparatus to determine a core price for a flight meeting said air travel parameters;
fourth computer-readable program code for causing the computing apparatus to determine at least one price differential associated with the at least one selected service attribute;
fifth computer-readable program code for causing the computing apparatus to determine a purchase price based on the core price and the at least one price differential;
sixth computer-readable program code for causing the computing apparatus to cause the purchase price to be displayed via the GUI; and
seventh computer-readable program code for causing the computing apparatus to be attentive to cause said flight to be booked in response to receipt of a confirmation made via the GUI of an intent to purchase a ticket for said flight at the purchase price.

According to a third broad aspect, the present invention seeks to provide an air travel services architecture, comprising
a computing apparatus implementing a graphical user interface (GUI) that enables a user thereof to purchase air travel services;
a server communicatively coupled to the computing apparatus over a network, the server being configured for:
   receiving air travel parameters submitted via the GUI;
   receiving a selection made via the GUI, the selection being indicative of at least one selected service attribute from a service attribute set;
   determining a core price for a flight meeting said air travel parameters;
   determining at least one price differential associated with the at least one selected service attribute;
   determining a purchase price based on the core price and the at least one price differential;
   causing the purchase price to be displayed via the GUI; and
   causing said flight to be booked in response to receipt of a confirmation made via the GUI of an intent to purchase a ticket for said flight at the purchase price.

According to a fourth broad aspect, the present invention seeks to provide a method to enable a user of a computer-implemented graphical user interface (GUI) to purchase air travel services, comprising:
receiving air travel parameters submitted via the GUI;
determining a core price for a flight meeting said air travel parameters;
causing the core price to be displayed via the GUI;
subsequent to causing the core price to be displayed via the GUI, causing the GUI to provide the user with an opportunity to make a selection of at least one service attribute from a set of at least one service attribute;
determining a purchase price for said flight based on the core price and a price differential associated with the selection;
causing the purchase price to be displayed via the GUI; and
causing the GUI to provide the user with an opportunity to confirm an intent to purchase a ticket for said flight at the purchase price.

According to a fifth broad aspect, the present invention seeks to provide a computer-readable medium comprising computer-readable program code which, when interpreted by a computing apparatus, causes the computing apparatus to execute a method to enable a user of a computer-implemented graphical user interface (GUI) to purchase air travel services, the computer-readable program code comprising:
first computer-readable program code for causing the computing apparatus to be attentive to receipt of air travel parameters submitted via the GUI;
second computer-readable program code for causing the computing apparatus to determine a core price for a flight meeting said air travel parameters;
third computer-readable program code for causing the computing apparatus to cause the core price to be displayed via the GUI;
fourth computer-readable program code for causing the computing apparatus to causing the GUI to subsequently provide the user with an opportunity to make a selection of at least one service attribute from a set of at least one service attribute;
fifth computer-readable program code for causing the computing apparatus to determine a purchase price for said flight based on the core price and a price differential associated with the selection;
sixth computer-readable program code for causing the computing apparatus to cause the purchase price to be displayed via the GUI; and
seventh computer-readable program code for causing the computing apparatus to cause the GUI to provide the user with an opportunity to confirm an intent to purchase a ticket for said flight at the purchase price.

According to a sixth broad aspect, the present invention seeks to provide an air travel services architecture, comprising
a computing apparatus implementing a graphical user interface (GUI) that enables a user thereof to purchase air travel services;
a server communicatively coupled to the computing apparatus over a network, the server being configured for:
   receiving air travel parameters submitted via the GUI;
   determining a core price for a flight meeting said air travel parameters;
   causing the core price to be displayed via the GUI;
   subsequent to causing the core price to be displayed via the GUI, causing the GUI to provide the user with an opportunity to make a selection of at least one service attribute from a set of at least one service attribute;
   determining a purchase price for said flight based on the core price and a price differential associated with the selection;
   causing the purchase price to be displayed via the GUI; and
   causing the GUI to provide the user with an opportunity to confirm an intent to purchase a ticket for said flight at the purchase price.

According to a seventh broad aspect, the present invention seeks to provide a method to enable a user of a computer-implemented graphical user interface (GUI) to purchase air travel services from an air travel service provider operating a networked computer, comprising:
conveying to the networked computer a selection of a flight and a service level for said flight entered by the user via the GUI;
conveying to the networked computer a selection entered by the user via the GUI, said selection indicative of at least one selected service attribute from a service attribute set;
conveying to the user via the GUI a core price for said flight received from the networked computer;
conveying to the user via the GUI a purchase price for said flight received from the networked computer, the purchase price having been impacted by the selection; and
conveying to the networked computer a confirmation of an intent to purchase said flight at the purchase price, said confirmation having been entered by the user via the GUI.

According to an eighth first broad aspect, the present invention seeks to provide a computer-readable medium comprising computer-readable program code which, when interpreted by a computing apparatus, causes the computing apparatus to execute a method to enable a user of a computer-implemented graphical user interface (GUI) to purchase air travel services from an air travel service provider operating a networked computer, the computer-readable program code comprising:
first computer-readable program code for causing the computing apparatus to convey to the networked computer a selection of a flight and a service level for said flight entered by the user via the GUI;
second computer-readable program code for causing the computing apparatus to convey to the networked computer a selection entered by the user via the GUI, said selection indicative of at least one selected service attribute from a service attribute set;
third computer-readable program code for causing the computing apparatus to convey to the user via the GUI a core price for said flight received from the networked computer;
fourth computer-readable program code for causing the computing apparatus to convey to the user via the GUI a purchase price for said flight received from the networked computer, the purchase price having been impacted by the selection; and
fifth computer-readable program code for causing the computing apparatus to convey to the networked computer a confirmation of an intent to purchase said flight at the purchase price, said confirmation having been entered by the user via the GUI.

According to a ninth broad aspect, the present invention seeks to provide a computing apparatus for use in purchasing air travel services from an air travel service provider operating a networked computer, the computing apparatus comprising:
means for implementing a graphical user interface (GUI);
means for conveying to the networked computer a selection of a flight and a service level for said flight entered by the user via the GUI;
means for conveying to the networked computer a selection entered by the user via the GUI, said selection indicative of at least one selected service attribute from a service attribute set;
means for conveying to the user via the GUI a core price for said flight received from the networked computer;
means for conveying to the user via the GUI a purchase price for said flight received from the networked computer, the purchase price having been impacted by the selection; and
means for conveying to the networked computer a confirmation of an intent to purchase said flight at the purchase price, said confirmation having been entered by the user via the GUI.

According to a tenth broad aspect, the present invention seeks to provide a method to enable a user of a computer-implemented graphical user interface (GUI) to purchase air travel services, comprising:
receiving via the GUI an indication of a selected flight;
receiving a selection made via the GUI, the selection being indicative of a desire to forfeit a prospective credit of a non-monetary reward for having purchased the selected flight;
determining a monetary rebate associated with the non-monetary reward;
determining a purchase price based on (i) a core price for the selected flight and (ii) the monetary rebate;
booking the selected flight in response to receipt of a confirmation made via the GUI of an intent to purchase the selected flight at the purchase price.

According to an eleventh broad aspect, the present invention seeks to provide a computer-readable medium comprising computer-readable program code which, when interpreted by a computing apparatus, causes the computing apparatus to execute a method to enable a user of a computer-implemented graphical user interface (GUI) to purchase air travel services, the computer-readable program code comprising:
first computer-readable program code for causing the computing apparatus to be attentive to receipt via the GUI of an indication of a selected flight;
second computer-readable program code for causing the computing apparatus to be attentive to receipt of a selection made via the GUI, the selection being indicative of a desire to forfeit a prospective credit of a non-monetary reward for having purchased the selected flight;
third computer-readable program code for causing the computing apparatus to determine a monetary rebate associated with the non-monetary reward;
fourth computer-readable program code for causing the computing apparatus to determine a purchase price based on (i) a core price for the selected flight and (ii) the monetary rebate;
fifth computer-readable program code for causing the computing apparatus to book the selected flight in response to receipt of a confirmation made via the GUI of an intent to purchase the selected flight at the purchase price.

According to a twelfth broad aspect, the present invention seeks to provide a method to enable a user of a computer-implemented graphical user interface (GUI) to purchase air travel services, comprising:
receiving an indication of a selected flight and a selected service level for the selected flight, as submitted via the GUI;
causing a set of at least one service attribute to be displayed via the GUI, the at least one service attribute being included with flights at a service level higher than the selected service level and not included with flights at the selected service level;
receiving a selection made via the GUI, the selection being indicative of zero or more selected service attributes from the set of at least one service attribute;
determining a purchase price for the selected flight based on the selected service level and the zero or more selected service attributes;
causing the purchase price to be displayed via the GUI; and
causing the selected flight to be booked in response to receipt of a confirmation made via the GUI of an intent to purchase the selected flight at the purchase price.

According to a thirteenth broad aspect, the present invention seeks to provide a computer-readable medium comprising computer-readable program code which, when interpreted by a computing apparatus, causes the computing apparatus to execute a method to enable a user of a computer-implemented graphical user interface (GUI) to purchase air travel services, the computer-readable program code comprising:
first computer-readable program code for causing the computing apparatus to be attentive to receipt of an indication of a selected flight and a selected service level for the selected flight, as submitted via the GUI;
second computer-readable program code for causing the computing apparatus to cause a set of at least one service attribute to be displayed via the GUI, the at least one service attribute being included with flights at a service level higher than the selected service level and not included with flights at the selected service level;
third computer-readable program code for causing the computing apparatus to be attentive to receipt of a selection made via the GUI, the selection being indicative of zero or more selected service attributes from the set of at least one service attribute;
fourth computer-readable program code for causing the computing apparatus to determine a purchase price for the selected flight based on the selected service level and the zero or more selected service attributes;
fifth computer-readable program code for causing the computing apparatus to cause the purchase price to be displayed via the GUI; and
sixth computer-readable program code for causing the computing apparatus to cause the selected flight to be booked in response to receipt of a confirmation made via the GUI of an intent to purchase the selected flight at the purchase price.

According to a fourteenth broad aspect, the present invention seeks to provide an air travel services architecture, comprising
a computing apparatus implementing a graphical user interface (GUI) that enables a user thereof to purchase air travel services;
a server communicatively coupled to the computing apparatus over a network, the server being configured for:
   receiving an indication of a selected flight and a selected service level for the selected flight, as submitted via the GUI;
   causing a set of at least one service attribute to be displayed via the GUI, the at least one service attribute being included with flights at a service level higher than the selected service level and not included with flights at the selected service level;
   receiving a selection made via the GUI, the selection being indicative of zero or more selected service attributes from the set of at least one service attribute;
   determining a purchase price for the selected flight based on the selected service level and the zero or more selected service attributes;
   causing the purchase price to be displayed via the GUI; and
   causing the selected flight to be booked in response to receipt of a confirmation made via the GUI of an intent to purchase the selected flight at the purchase price.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram depicting the configuration of an air travel services architecture, in accordance with a non-limiting embodiment of the present invention;

FIG. 2 illustrates an example of a search page for allowing a user to specify air travel parameters, in accordance with a non-limiting embodiment of the present invention;

FIG. 3 illustrates an example of a select page for allowing the user to select a flight from a plurality of flights for one or more origin-destination segments, in accordance with a non-limiting embodiment of the present invention;

FIG. 4 illustrates an attributes page, in accordance with a non-limiting embodiment of the present invention;

FIG. 5 illustrates an example of a review page for allowing the user to proceed with payment for a selected set of flights, in accordance with a non-limiting embodiment of the present invention;

FIG. 6 illustrates a boarding pass in accordance with a non-limiting embodiment of the present invention.

It is to be expressly understood that the description and drawings are only for the purpose of illustration of certain embodiments of the invention and are an aid for understanding. They are not intended to be a definition of the limits of the invention.

### DETAILED DESCRIPTION OF NON-LIMITING EMBODIMENTS

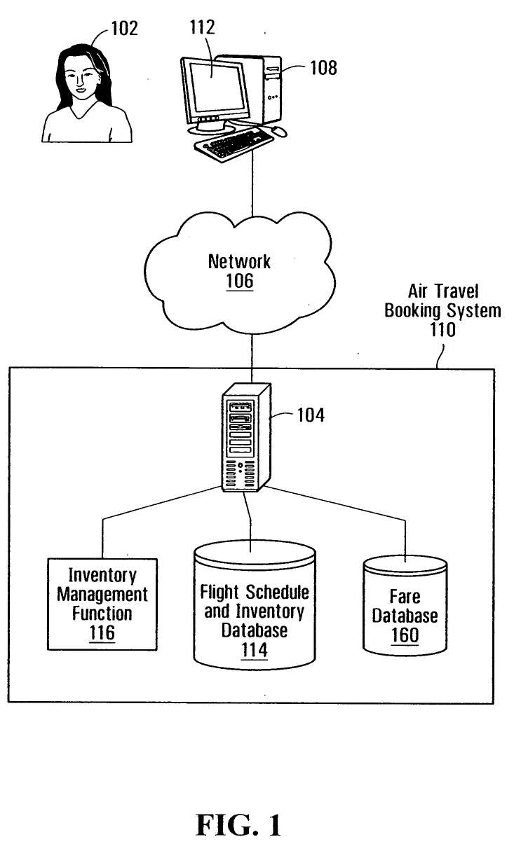

With reference to FIG. 1, a non-limiting process for enabling a user 102 to purchase air travel services will now be described in the context of an air travel services architecture comprising an air travel booking system 110 including a server 104 that is accessible over a network 106. The server 104 acts as a gateway between a computing apparatus 108 connected to the network 106 and a remainder of the air travel booking system 110. In a specific non-limiting embodiment, the server 104 is a web server.

The computing apparatus 108 and the network 106 are not particularly limited to any specific implementation. For example, the network 106 may comprise a portion of the public switched telephone network (PSTN), a public data network (such as the Internet), a private data network (such as Galileo, Sabre, etc.), a virtual private network, a wireless network, etc. Also, the computing apparatus 108 may be a desktop PC, a laptop, a smart phone, a networked wireless personal communication device (such as Treo, BlackBerry, etc.), and so on.

The computing apparatus 108 is configured to execute a software application 112 which implements a graphical user interface (GUI). In a non-limiting example embodiment, the software application 112 may be embodied as computer-readable program code stored on a computer-readable medium such as a memory of the computing apparatus 108. The computer-readable program code may comprise sections of code for executing various steps in a method involving the GUI, as described in further detail herein below.

In a non-limiting example, the software application 112 may be an Internet browser application. The GUI allows the user 102 to specify to the browser that communication is desired with the server 104, e.g., by entering an address of the server 104 (such as “http://www.aircanada.com”). The browser then seeks to establishes communication with the server 104 over the network 106 and subsequently cooperates with the server 104 to allow the user 102 to convey via the GUI information destined for the server 104 (as well as for the remainder of the air travel booking system 110), and also to allow information from the server 104 (as well as from the remainder of the air travel booking system 110) to be conveyed to the user 102 via the GUI. Accordingly, the server 104 may also be configured to execute a software application, which can be embodied as computer-readable program code stored on a computer-readable medium such as a memory of the server 104. The computer-readable program code may comprise sections of code for executing various steps as described in further detail herein below.

In addition to comprising the server 104, the air travel booking system 110 comprises various functional components to allow a seat or seats to be booked on a desired flight or flights based on interaction with the user 102 via the GUI. To this end, the air travel booking system 110 includes, among other components, a flight schedule and inventory database 114, an inventory management function 116 and a fare database 160.

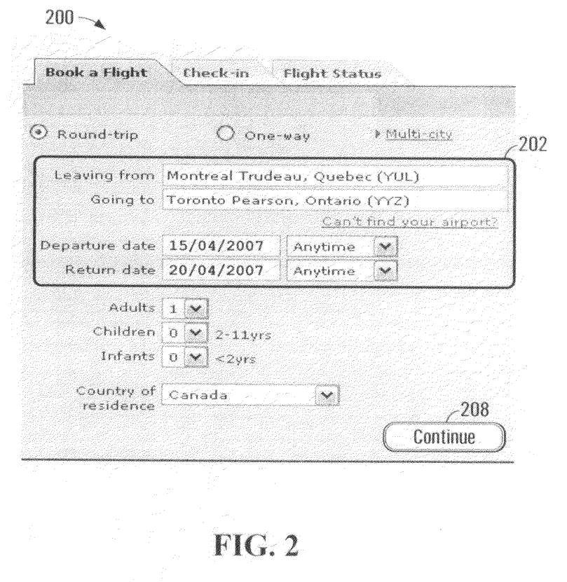

With reference now to FIG. 2, there is shown an example of a graphical element 200, hereinafter referred to as a “search page”, that the server 104 causes to be displayed on the computing apparatus 108 via the GUI. The search page 200 allows the user 102 to input air travel parameters to the server 104. To this end, the search page 200 comprises a region 202 that permits the user 102 to specify, for example, origin and destination information (such as by city name or airport code), as well as schedule information (such as a departure date and a return date). Of course, other regions may be provided on the search page 200 (and/or on other pages), thereby allowing additional air travel parameters to be specified, without departing from the scope of the present invention. Such additional air travel parameters may include, without limitation: a number of passengers, a specific airline, a country of residence, a range of dates instead of a specific date, whether the trip is one-way or return, etc.

The search page 200 further comprises a parameter conveyance mechanism 208 (e.g., button, hyperlink, arrow, etc.) that can be actioned by the user 102 via an appropriate input device (e.g., mouse, keyboard, stylus, touch sensitive input screen, speech recognition utility). When the parameter conveyance mechanism 208 is so actioned, this event is detected by the server 104, which then initiates a search in the flight schedule and inventory database 114 of the air travel booking system 110 for availability of a seat on a flight (or sequence of flights) that meets the air travel parameters specified by the user 102. There may be more than one flight (or more than one sequence of flights) meeting the air travel parameters specified by the user 102. Where the air travel parameters specify a return trip, a separate set of one or more flights (or sequences of flights) may exist for each of two “origin-destination segments”.

Assuming the existence of at least one flight for each origin-destination segment on which the requisite number of seats is available, the air travel booking system 110 returns to the server 104 certain flight information related to each flight, including a confirmation of the origin and destination, as well as flight time, flight number, aircraft data, connections, etc. Optionally, the air travel booking system 110 may temporarily reserve the requisite number of seats on each flight, for each origin-destination segment.

In addition, the air travel booking system 110 returns to the server 104 certain price information related to each flight. The price information related to a given flight comprises one or more “core prices” for the given flight, each such core price being associated with a respective “service level”. In this example, a set of three service levels is provided, including “bronze”, “silver” and “gold”, but this is not to be considered a limitation of the present invention. The core price for a given flight at a given service level indicates the price to be charged to the user 102 for air travel on the given flight at the given service level. The core prices for various possible flights at various possible service levels can be stored in the aforesaid fare database 160. The number of seats allotted to different service levels and the corresponding core prices may be governed by the inventory management function 116.

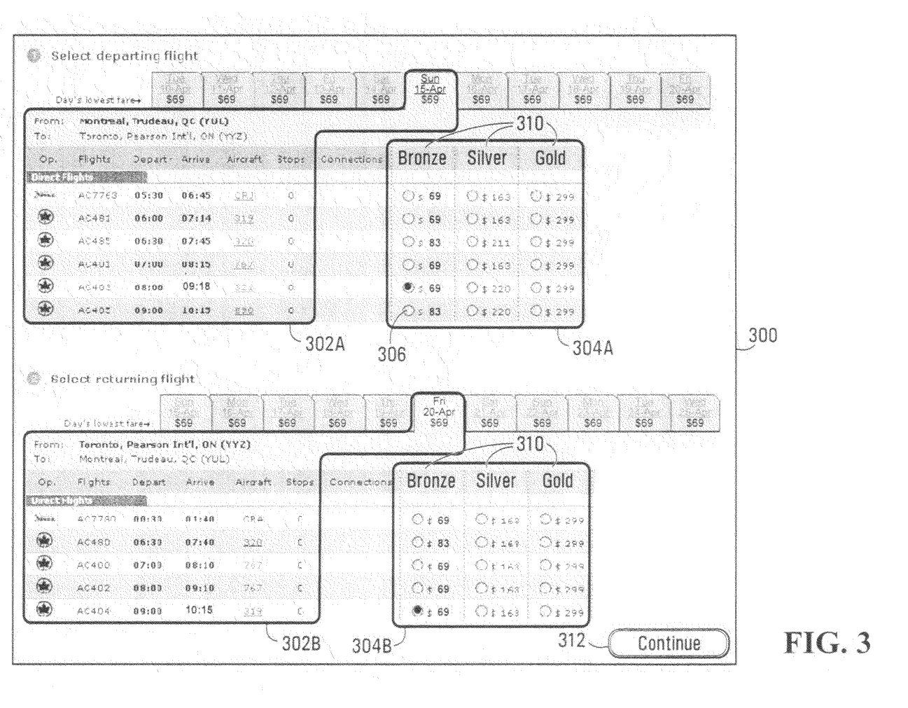

Based on the flight information and price information received from the air travel booking system 110, the server 104 changes the page displayed by the GUI. Specifically, with reference now to FIG. 3, a graphical element 300 is displayed, hereinafter referred to as a “select page”. The select page 300 may comprise a region 302A that displays the flight information related to each available flight for an “outbound” origin-destination segment, and a region 302B that displays the flight information related to each available flight for an “inbound” origin-destination segment. The information displayed in regions 302A and 302B includes the respective origin and destination, as well as flight times, flight numbers, aircraft data, connections, etc. For convenience, and in accordance with a specific non-limiting embodiment, the flight information for a given origin-destination segment may be displayed in the form of a table, where each row of the table is associated with a respective available flight for the given origin-destination segment.

The select page 300 may further comprise a region 304A that displays the price information related to each available flight for the outbound origin-destination segment, and a region 304B that displays the price information related to each available flight for the inbound origin-destination segment. In a non-limiting example embodiment, where the flight information is displayed in each of the regions 302A, 302B as a corresponding table of rows associated with respective available flights, each of the regions 304A, 304B displays one or more columns per row of the corresponding table (i.e., per available flight). Each column for a given available flight contains a core price for a corresponding service level. Naturally, the data to be displayed on the select page 300 may be organized in a variety of other ways while remaining within the scope of the present invention.

In addition, the select page 300 comprises a mechanism that permits the user 102 to select an available flight at a given service level, for each origin-destination segment. In a specific non-limiting embodiment, this may be achieved by providing a radio button 306 (or check box, etc.) in the vicinity of each core price in the regions 304A, 304B. For each origin-destination segment, the user 102 may be permitted to select only one core price. Thus, as is the case in the present non-limiting example, where there are two origin-destination segments, the user 102 may be permitted to select only one core price (i.e., one available flight at a single service level) per origin-destination segment. However, it is contemplated that in other embodiments, the user 102 may be permitted to select multiple available flights and/or service levels.

The selected flight and service level for the outbound origin-destination segment are hereinafter referred to as a “selected outbound flight” and a “selected outbound service level”, respectively. The corresponding core price is hereinafter referred to as a “selected outbound core price”. Analogously, the selected flight and service level for the inbound origin-destination segment are hereinafter referred to as a “selected inbound flight” and a “selected inbound service level”, respectively. The corresponding core price is hereinafter referred to as a “selected inbound core price”. Naturally, the service level may be the same for both the selected outbound flight and the selected inbound flight.

The select page 300 further comprises a flight selection conveyance mechanism 312 (e.g., button, hyperlink, arrow, etc.) that can be actioned by the user 102 via an appropriate input device (e.g., mouse, keyboard, stylus, touch sensitive input screen, speech recognition utility). When the flight selection conveyance mechanism 312 is so actioned, this event is detected by the server 104, which then effects a reservation in the flight schedule and inventory database 114 of the air travel booking system 110, based on the selected outbound flight and the selected outbound service level, as well as on the selected inbound flight and the selected inbound service level.

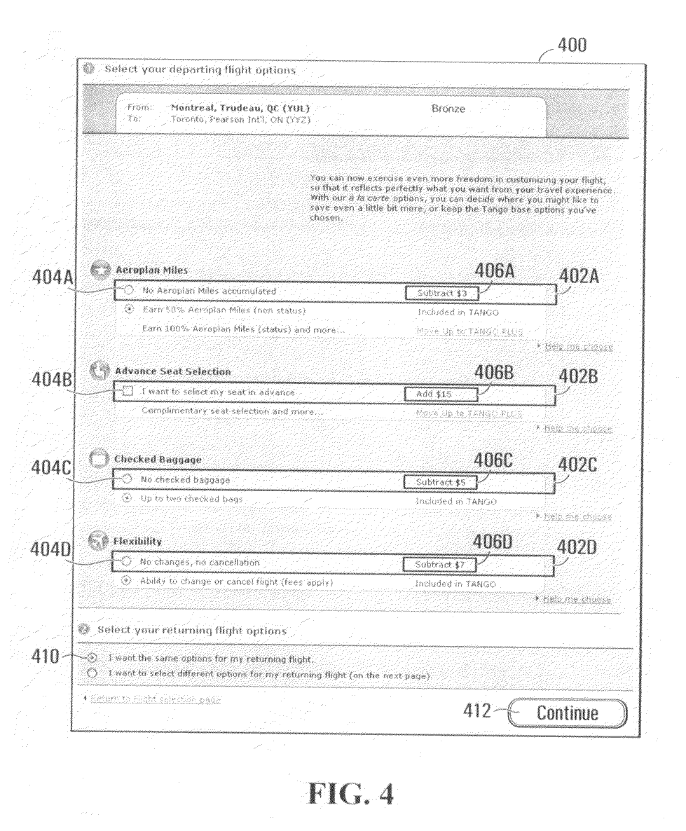

Additionally, and with reference now to FIG. 4, the server 104 causes the GUI to display a graphical element 400, hereinafter referred to as an “attributes page”. The attributes page 400 displays a set of regions 402A . . . D each corresponding to a respective “service attribute” for the selected outbound flight. Similar sets of regions corresponding to respective service attributes for the selected inbound flight may be displayed on the same attributes page 400 or on a different attributes page. For instance, in the non-limiting example shown, the attributes page 400 comprises a conveyance mechanism 410 that permits the user 102 to either indicate that he/she desires the same service attribute(s) for the selected inbound flight or access a different attributes page via which he/she can select one or more different service attributes for the selected inbound flight. For convenience, but without limiting the scope of the present invention, the following discussion will assume that the attributes page 400 pertains to both the selected inbound flight and the selected outbound flight.

Each of the regions 402A . . . D displays a respective attribute selection mechanism 404A . . . D, which allows the user 102 to “select” the respective service attribute via an appropriate input device (e.g., mouse, keyboard, stylus, touch sensitive input screen, speech recognition utility). Non-limiting examples of the attribute selection mechanism 404A . . . D include a radio button, a check box, etc. that can be activated by the user 102. Furthermore, for each service attribute, the corresponding one of the regions 402A . . . D comprises a respective sub-region 406A . . . D graphically conveying a “price differential” for that service attribute. The price differential for a given service attribute represents either a surcharge or a rebate to be applied to the core price if that service attribute is selected (that is, if the corresponding attribute selection mechanism 404A . . . D is activated.)

A given service attribute may or may not be an in-flight service attribute. An in-flight service attribute pertains to a service directly related to the selected inbound or outbound flight. Non-limiting examples of in-flight service attributes pertain to seat selection, checked baggage and meal vouchers, to name a few possibilities. A service attribute that is not an in-flight service attribute is a service attribute not directly related to the selected inbound or outbound flight. Non-limiting examples of service attributes that are not in-flight service attributes pertain to flight change/cancellation, credit of a non-monetary reward (e.g., frequent flyer miles, loyalty points) and lounge access, to name a few possibilities.

It should be appreciated that certain service attributes that are associated with a price differential which is a rebate, may denote service attributes that would ordinarily be included in the core price. For example, in the non-limiting example attributes page 400 of FIG. 4, one of the illustrated service attributes is associated with an attribute selection mechanism 404D in the vicinity of the expression “no changes, no cancellation” under the heading “flexibility”, and is further associated with a sub-region 406D graphically conveying a price differential that is a rebate of $7 if the attribute selection mechanism 404D is activated. It is contemplated that an entitlement to make changes or cancellations may ordinarily be included in the core price at the service level being considered here. However, by forfeiting the entitlement to make changes or cancellations, the user 102 obtains a rebate of $7 off the core price.

It should further be appreciated that certain service attributes that are associated with a price differential which is a surcharge at one service level, may correspond to a service attribute that is actually included in the core price at a higher service level. For example, in the non-limiting example attributes page 400 of FIG. 4, which by way of illustration contemplates the “bronze” service level, one of the illustrated service attributes is associated with an attribute selection mechanism 404B in the vicinity of the expression “I want to select my seat in advance” under the heading “advance seat selection”, and is further associated with a sub-region 406B graphically conveying a price differential that is a surcharge of $15 if the attribute selection mechanism 404B is activated. It is contemplated that advance seat selection may, however, be part of the core price at the “silver” or “gold” service levels.

Additionally, another illustrated service attribute in the non-limiting example attributes page 400 of FIG. 4 is associated with an attribute selection mechanism 404C in the vicinity of the expression “no checked baggage” under the heading “checked baggage”, and is further associated with a sub-region 406C graphically conveying a price differential that is a rebate of $5 if the attribute selection mechanism 404C is activated. It is contemplated that an entitlement to check baggage may ordinarily be included in the core price at the service level being considered here. However, by forfeiting the entitlement to check baggage, the user 102 obtains a rebate of $5 off the core price.

Finally, another illustrated service attribute in the non-limiting example attributes page 400 of FIG. 4 is associated with an attribute selection mechanism 404A in the vicinity of the expression “no frequent flyer points accumulated” under the heading “frequent flyer points”, and is further associated with a sub-region 406A graphically conveying a price differential that is a rebate of $3 if the attribute selection mechanism 404A is activated. It is contemplated that an entitlement to frequent flyer points may ordinarily be included in the core price at the service level being considered here. However, by forfeiting the entitlement to frequent flyer points, the user 102 obtains a rebate of $3 off the core price.

In the latter example, it will be appreciated that forfeiture of an entitlement to frequent flyer points is one example of forfeiture of a prospective credit of a non-monetary reward. In accordance with embodiments of the present invention, such forfeiture is converted into a monetary rebate applied against the price of a ticket for the very flight that would have allowed the non-monetary reward to be collected.

Persons skilled in the art will appreciate that a different set of service attributes may be illustrated on the attributes page 400, and the total number of service attributes that the user 102 may choose from is not particularly limited. Moreover, when the number of service attributes is large, more than one attribute page may be needed to allow the user 102 to navigate in a user-friendly manner across all of the available attributes. Also, it is within the scope of the present invention to provide a separate attributes page for each service attribute.

Other examples of other service attributes that can be associated with a surcharge or a discount relative to the core price at a given service level include, without limitation:
an entitlement to, or forfeiture of entitlement to, a same day airport change;
an entitlement to, or forfeiture of entitlement to, same day standby;
an entitlement to, or forfeiture of entitlement to, a full or partial refund in the event of a cancellation;
an entitlement to, or forfeiture of entitlement to, priority treatment for check-in, baggage and/or boarding;
an entitlement to, or forfeiture of entitlement to, carry sports equipment or check in excess baggage;
an entitlement to, or forfeiture of entitlement to, a meal on-board;
an entitlement to, or forfeiture of entitlement to, lounge access;
etc.

Thus, using the attributes page 400, the user 102 decides which service attributes to select for the selected outbound and inbound flights. The service attributes selected by the user 102 in this manner are hereinafter referred to as “selected outbound service attributes” and “selected inbound service attributes” for the selected outbound and inbound flights, respectively. It should be appreciated that the user 102 may select none of the service attributes for which corresponding regions 402A . . . D have been displayed. This would simply mean that there will not be a change in the core price for the selected outbound and/or inbound flight. For purposes of this example, assume that the user 102 selects the service attributes associated with the attribute selection mechanisms 404B, 404C and 404D, for both the selected outbound flight and the selected inbound flight.

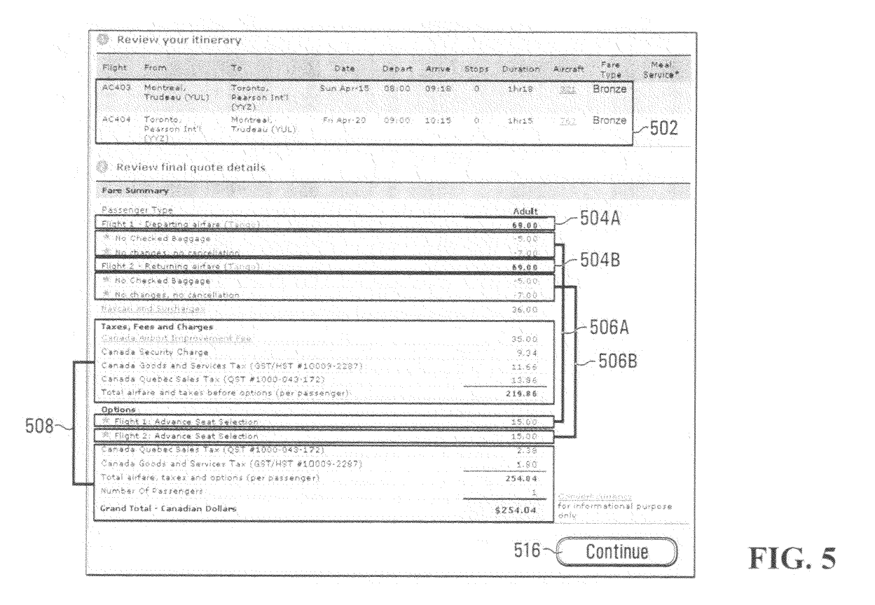

The attributes page 400 further comprises a selected attributes conveyance mechanism 412 (e.g., button, hyperlink, arrow, etc.) that can be actioned by the user 102 via an appropriate input device (e.g., mouse, keyboard, stylus, touch sensitive input screen, speech recognition utility) in order to confirm selection of the selected outbound service attributes and the selected inbound service attributes. Upon actioning of the selected attributes conveyance mechanism 412, and with reference now to FIG. 5, the server 104 causes the GUI to display a graphical element 500, hereinafter referred to as a “review page”.

The review page 500 may comprise a region 502 that displays the flight information related to the selected outbound flight and the selected inbound flight. The review page 500 may also comprise a region 504A that displays the selected outbound core price which, as stated earlier, depends on the outbound service level for the selected outbound flight. In this example case of a round trip, the review page 500 may also comprise a region 504B that displays the selected inbound core price, which depends on the inbound service level for the selected inbound flight.

The review page 500 may further comprise a region 506A that displays the price differentials corresponding to the selected outbound services attributes, and a region 506B that displays the price differentials corresponding to the selected inbound service attributes. It should be recalled that these price differentials may, on an individual basis, be positive (i.e., in the case of a surcharge) or negative (i.e., in the case of a rebate). Thus, it will be noted that there may be a financial impact of having selected certain service attributes for a given flight. This financial impact can be visually presented to the user 102 via the GUI on an attribute-by-attribute basis. It should be appreciated that the region 506A may be visually concentrated, clustered or distributed throughout the review page 500, thus providing a logical and/or esthetical grouping of the selected outbound the selected attributes, e.g., according to whether they each represent a rebate or a surcharge.

The review page 500 may further comprise a region 508 that displays ancillary financial data such as taxes, other surcharges, grand total, etc. Thus, it should be noted that the price differentials of the selected inbound and outbound attributes will amount to a net price adjustment. For instance, in the present example of FIGS. 4 and 5, the net price adjustment resulting from having selected the service attributes associated with the attribute selection mechanisms 404B, 404C and 404D is a surcharge of $3 ( that is, +$15+(−$5)+(−7)=+$3) for each of the selected outbound flight and the selected inbound flight.

Of course, situations may arise where the net price adjustment resulting from having selected a different combination of service attributes may be zero. In fact, this would be the case if the service attributes associated with all four of the attribute selection mechanisms 404A . . . D were selected on the attributes page 400 (that is, +$15+(−$15)=$0). It should be noted that despite an apparent nil impact on the price paid for air travel, the user 102 is nevertheless able to customize his or her journey in order to enjoy certain attributes typically available only at higher service levels by simply agreeing to give up certain other privileges typically included at the selected service level.

Generally, it will be appreciated how the user 102 is able to select or give up various service attributes, some of which are “standard” at a higher service level. The user 102 is thus not only able to make tailored purchases of air travel serviced in an “a la carte” fashion, but the selections made by the user are reflected in the price to be paid for the ticket.

The review page 500 may also comprise a purchase conveyance mechanism 516 (e.g., button, hyperlink, arrow, etc.) that can be actioned by the user 102 via an appropriate input device (e.g., mouse, keyboard, stylus, touch sensitive input screen, speech recognition utility) when the user 102 wishes to confirm an intent to purchase air travel in accordance with the various parameters specified until now in the process. When the purchase conveyance mechanism 516 is so actioned, this event is detected by the server 104, which then causes a seat reservation to be made on the selected outbound flight using the flight schedule and inventory database 114 of the air travel booking system 110, in accordance with the selected outbound service level and the selected outbound service attributes. In addition, for a round trip, the server 104 causes a seat reservation to be made on the selected inbound flight using the flight schedule and inventory database 114 of the air travel booking system 110, in accordance with the selected inbound service level and the selected inbound service attributes.

In addition, actioning of the purchase conveyance mechanism 516 can initiate a financial transaction, e.g., via conventional or e-commerce means. It will be apparent that the dollar amount transacted will be a function of the selected outbound and inbound service levels as well as the selected outbound and inbound service attributes. The aforesaid seat reservations may thus be held for a certain amount of time to allow the financial transaction to be confirmed.

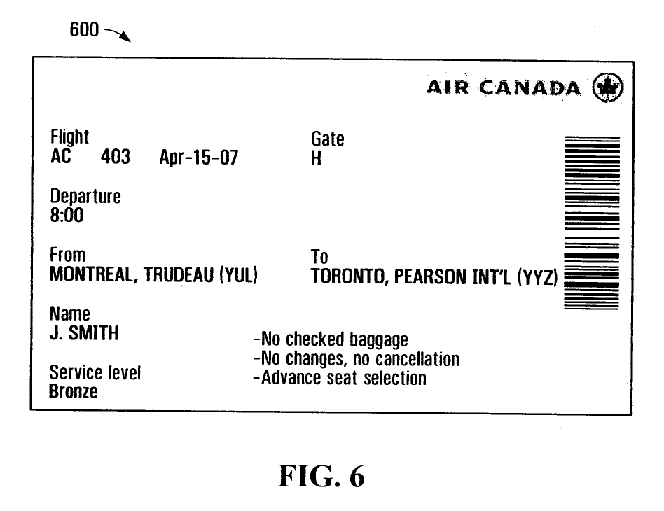

Upon confirmation of the financial transaction effected subsequent to actioning of the purchase conveyance mechanism 516, the air travel booking system 110 issues a ticket for the selected inbound and outbound flights, which can be electronic in nature. At the same time or subsequently (e.g., when the user 102 arrives at the airport), and with reference to FIG. 6, the air travel booking system 110 may issue a boarding pass 600 for the selected outbound flight. In addition to the various standard components of a boarding pass, the boarding pass 600 issued in accordance with non-limiting embodiments of the present invention may graphically convey (e.g., using pictograms, characters, bar codes, Braille, etc.) the selected outbound service level and the selected outbound service attributes.

The specially marked boarding pass 600 can allow the flight crew and other personnel to determine what type of service should be given to the passenger to whom the boarding pass 600 has been issued. Issuance of a boarding pass for the selected inbound flight is analogous. Also, in the case where the prospective credit of a non-monetary reward has been forfeited, and if the passenger sends in the boarding pass to a rewards processing agency in order to collect rewards (either by mistake or fraudulently), then the specially marked boarding pass 600 allows the reward processing agency to determine that the non-monetary reward ordinarily attributable to the flight in question cannot in this case be collected.

Of course, the above described embodiments are intended to be illustrative only and in no way limiting. The described embodiments are susceptible to many modifications, such as modifications of form, arrangement of parts, details and order of operation. The invention, rather, is intended to encompass all such modifications within its scope, as defined by the claims.

What is claimed is:

1. A method to enable a user of a computer-implemented graphical user interface (GUI) to purchase air travel services, comprising:
receiving air travel parameters submitted via the GUI;
receiving a selection made via the GUI, the selection being indicative of at least one selected service attribute from a service attribute set;
determining a core price for a flight meeting said air travel parameters;
determining at least one price differential associated with the at least one selected service attribute;
determining a purchase price based on the core price and the at least one price differential;
causing the purchase price to be displayed via the GUI; and
causing said flight to be booked in response to receipt of a confirmation made via the GUI of an intent to purchase a ticket for said flight at the purchase price.

2. The method defined in claim 1, wherein the air travel parameters comprise an indication of an origin and a destination, and wherein said determining a core price comprises consulting a flight schedule and inventory database using the origin and destination as inputs.

3. The method defined in claim 1, wherein the GUI is implemented as a browser on a client computing apparatus and wherein the method is executed on at least one computer operatively connected to the client computing apparatus via a data network.

4. The method defined in claim 1, further comprising:
causing the service attribute set to be displayed via the GUI.

5. The method defined in claim 4, further comprising, after causing the purchase price to be displayed via the GUI:
receiving a revised selection made via the GUI, the revised selection being indicative of at least one previously unselected service attribute from the service attribute set.

6. The method defined in claim 1, further comprising causing issuance of a boarding pass for said flight, said boarding pass comprising at least one graphical element indicative of the at least one selected service attribute.

7. The method defined in claim 6, wherein the graphical element is expressed in the form of a pictogram, a character, a bar code and Braille.

8. The method defined in claim 1, wherein one of the service attributes in the service attribute set comprises an option to exchange, prior to booking, an entitlement to frequent flier points associated with said flight for a price differential that is a rebate.

9. The method defined in claim 1, wherein said determining a purchase price based on the core price and the at least one price differential comprises adding each of the at least one price differential to the core price.

10. The method defined in claim 1, wherein the purchase price is greater than the core price.

11. The method defined in claim 1, wherein the purchase price is less than the core price.

12. The method defined in claim 1, wherein the purchase price is identical to the core price.

13. The method defined in claim 1, wherein selection of a particular selected service attribute includes entitlement to an added benefit and wherein the price differential associated with the particular selected service attribute is a surcharge.

14. The method defined in claim 13, wherein the air travel parameters comprise selected air travel parameters including a selected service level, wherein the added benefit is (i) not included in the core price for a flight meeting the selected air travel parameters and (ii) included in the core price for a flight meeting air travel parameters identical to the air travel parameters but with a service level higher than the selected service level.

15. The method defined in claim 1, wherein selection of a particular selected service attribute includes forfeiture of an entitlement to a benefit and wherein the price differential associated with the particular selected service attribute is a rebate.

16. The method defined in claim 15, wherein said benefit is included in the core price for said flight.

17. The method defined in claim 1, wherein the service attribute set comprises at least one service attribute that is an in-flight service attribute.

18. The method defined in claim 17, wherein the at least one service attribute that is an in-flight service attribute comprises an entitlement to a meal on-board said flight.

19. The method defined in claim 18, wherein the price differential associated with the at least one service attribute comprising an entitlement to a meal on-board said flight is a surcharge.

20. The method defined in claim 17, wherein the at least one service attribute that is an in-flight service attribute comprises forfeiture of an entitlement to a meal on-board said flight.

21. The method defined in claim 20, wherein the price differential associated with the at least one service attribute comprising forfeiture of an entitlement to a meal on-board said flight is a rebate.

22. The method defined in claim 17, wherein the at least one service attribute that is an in-flight service attribute comprises an entitlement to check in luggage.

23. The method defined in claim 22, wherein the price differential associated with the at least one service attribute comprising an entitlement to check in luggage is a surcharge.

24. The method defined in claim 17, wherein the at least one service attribute that is an in-flight service attribute comprises forfeiture of an entitlement to check in luggage.

25. The method defined in claim 24, wherein the price differential associated with the at least one service attribute comprising forfeiture of an entitlement to check in luggage is a rebate.

26. The method defined in claim 1, wherein the service attribute set comprises at least one service attribute that is not an in-flight service attribute.

27. The method defined in claim 26, wherein the at least one service attribute that is not an in-flight service attribute comprises an entitlement to lounge access.

28. The method defined in claim 27, wherein the price differential associated with the at least one service attribute comprising an entitlement to lounge access is a surcharge.

29. The method defined in claim 26, wherein the at least one service attribute that is not an in-flight service attribute comprises forfeiture of an entitlement to lounge access.

30. The method defined in claim 29, wherein the price differential associated with the at least one service attribute comprising forfeiture of an entitlement to lounge access is a rebate.

31. The method defined in claim 26, wherein the at least one service attribute that is not an in-flight service attribute comprises an entitlement to a parking space.

32. The method defined in claim 31, wherein the price differential associated with the at least one service attribute comprising an entitlement to a parking space is a surcharge.

33. The method defined in claim 26, wherein the at least one service attribute that is not an in-flight service attribute comprises forfeiture of an entitlement to a parking space.

34. The method defined in claim 33, wherein the price differential associated with the at least one service attribute comprising forfeiture of an entitlement to a parking space is a rebate.

35. The method defined in claim 1, further comprising causing the at least one price differential to be displayed via the GUI.

36. A computer-readable medium comprising computer-readable program code which, when interpreted by a computing apparatus, causes the computing apparatus to execute a method to enable a user of a computer-implemented graphical user interface (GUI) to purchase air travel services, the computer-readable program code comprising:
first computer-readable program code for causing the computing apparatus to be attentive to receipt of air travel parameters submitted via the GUI;
second computer-readable program code for causing the computing apparatus to be attentive to receipt of a selection made via the GUI, the selection being indicative of at least one selected service attribute from a service attribute set;
third computer-readable program code for causing the computing apparatus to determine a core price for a flight meeting said air travel parameters;
fourth computer-readable program code for causing the computing apparatus to determine at least one price differential associated with the at least one selected service attribute;
fifth computer-readable program code for causing the computing apparatus to determine a purchase price based on the core price and the at least one price differential;
sixth computer-readable program code for causing the computing apparatus to cause the purchase price to be displayed via the GUI; and
seventh computer-readable program code for causing the computing apparatus to be attentive to cause said flight to be booked in response to receipt of a confirmation made via the GUI of an intent to purchase a ticket for said flight at the purchase price.

37. An air travel services architecture, comprising
a computing apparatus implementing a graphical user interface (GUI) that enables a user thereof to purchase air travel services;
a server communicatively coupled to the computing apparatus over a network, the server being configured for:
receiving air travel parameters submitted via the GUI;
receiving a selection made via the GUI, the selection being indicative of at least one selected service attribute from a service attribute set;
determining a core price for a flight meeting said air travel parameters;
determining at least one price differential associated with the at least one selected service attribute;
determining a purchase price based on the core price and the at least one price differential;
causing the purchase price to be displayed via the GUI; and
causing said flight to be booked in response to receipt of a confirmation made via the GUI of an intent to purchase a ticket for said flight at the purchase price.

38. A method to enable a user of a computer-implemented graphical user interface (GUI) to purchase air travel services, comprising:
receiving air travel parameters submitted via the GUI;
determining a core price for a flight meeting said air travel parameters;
causing the core price to be displayed via the GUI;
subsequent to causing the core price to be displayed via the GUI, causing the GUI to provide the user with an opportunity to make a selection of at least one service attribute from a set of at least one service attribute;
determining a purchase price for said flight based on the core price and a price differential associated with the selection;
causing the purchase price to be displayed via the GUI; and
causing the GUI to provide the user with an opportunity to confirm an intent to purchase a ticket for said flight at the purchase price.

39. A computer-readable medium comprising computer-readable program code which, when interpreted by a computing apparatus, causes the computing apparatus to execute a method to enable a user of a computer-implemented graphical user interface (GUI) to purchase air travel services, the computer-readable program code comprising:
first computer-readable program code for causing the computing apparatus to be attentive to receipt of air travel parameters submitted via the GUI;
second computer-readable program code for causing the computing apparatus to determine a core price for a flight meeting said air travel parameters;
third computer-readable program code for causing the computing apparatus to cause the core price to be displayed via the GUI;
fourth computer-readable program code for causing the computing apparatus to causing the GUI to subsequently provide the user with an opportunity to make a selection of at least one service attribute from a set of at least one service attribute;
fifth computer-readable program code for causing the computing apparatus to determine a purchase price for said flight based on the core price and a price differential associated with the selection;
sixth computer-readable program code for causing the computing apparatus to cause the purchase price to be displayed via the GUI; and
seventh computer-readable program code for causing the computing apparatus to cause the GUI to provide the user with an opportunity to confirm an intent to purchase a ticket for said flight at the purchase price.

40. An air travel services architecture, comprising
a computing apparatus implementing a graphical user interface (GUI) that enables a user thereof to purchase air travel services;
a server communicatively coupled to the computing apparatus over a network, the server being configured for:
receiving air travel parameters submitted via the GUI;
determining a core price for a flight meeting said air travel parameters;
causing the core price to be displayed via the GUI;
subsequent to causing the core price to be displayed via the GUI, causing the GUI to provide the user with an opportunity to make a selection of at least one service attribute from a set of at least one service attribute;
determining a purchase price for said flight based on the core price and a price differential associated with the selection;
causing the purchase price to be displayed via the GUI; and
causing the GUI to provide the user with an opportunity to confirm an intent to purchase a ticket for said flight at the purchase price.

41. A method to enable a user of a computer-implemented graphical user interface (GUI) to purchase air travel services from an air travel service provider operating a networked computer, comprising:
conveying to the networked computer a selection of a flight and a service level for said flight entered by the user via the GUI;
conveying to the networked computer a selection entered by the user via the GUI, said selection indicative of at least one selected service attribute from a service attribute set;
conveying to the user via the GUI a core price for said flight received from the networked computer;
conveying to the user via the GUI a purchase price for said flight received from the networked computer, the purchase price having been impacted by the selection; and
conveying to the networked computer a confirmation of an intent to purchase said flight at the purchase price, said confirmation having been entered by the user via the GUI.

42. A computer-readable medium comprising computer-readable program code which, when interpreted by a computing apparatus, causes the computing apparatus to execute a method to enable a user of a computer-implemented graphical user interface (GUI) to purchase air travel services from an air travel service provider operating a networked computer, the computer-readable program code comprising:
first computer-readable program code for causing the computing apparatus to convey to the networked computer a selection of a flight and a service level for said flight entered by the user via the GUI;
second computer-readable program code for causing the computing apparatus to convey to the networked computer a selection entered by the user via the GUI, said selection indicative of at least one selected service attribute from a service attribute set;
third computer-readable program code for causing the computing apparatus to convey to the user via the GUI a core price for said flight received from the networked computer;
fourth computer-readable program code for causing the computing apparatus to convey to the user via the GUI a purchase price for said flight received from the networked computer, the purchase price having been impacted by the selection; and
fifth computer-readable program code for causing the computing apparatus to convey to the networked computer a confirmation of an intent to purchase said flight at the purchase price, said confirmation having been entered by the user via the GUI.

43. A computing apparatus for use in purchasing air travel services from an air travel service provider operating a networked computer, the computing apparatus comprising:
means for implementing a graphical user interface (GUI);
means for conveying to the networked computer a selection of a flight and a service level for said flight entered by the user via the GUI;
means for conveying to the networked computer a selection entered by the user via the GUI, said selection indicative of at least one selected service attribute from a service attribute set;
means for conveying to the user via the GUI a core price for said flight received from the networked computer;
means for conveying to the user via the GUI a purchase price for said flight received from the networked computer, the purchase price having been impacted by the selection; and
means for conveying to the networked computer a confirmation of an intent to purchase said flight at the purchase price, said confirmation having been entered by the user via the GUI.

44. A method to enable a user of a computer-implemented graphical user interface (GUI) to purchase air travel services, comprising:
receiving via the GUI an indication of a selected flight;
receiving a selection made via the GUI, the selection being indicative of a desire to forfeit a prospective credit of a non-monetary reward for having purchased the selected flight;
determining a monetary rebate associated with the non-monetary reward;
determining a purchase price based on (i) a core price for the selected flight and (ii) the monetary rebate;
booking the selected flight in response to receipt of a confirmation made via the GUI of an intent to purchase the selected flight at the purchase price.

45. The method defined in claim 44, further comprising:
causing the purchase price to be displayed via the GUI.

46. A computer-readable medium comprising computer-readable program code which, when interpreted by a computing apparatus, causes the computing apparatus to execute a method to enable a user of a computer-implemented graphical user interface (GUI) to purchase air travel services, the computer-readable program code comprising:
first computer-readable program code for causing the computing apparatus to be attentive to receipt via the GUI of an indication of a selected flight;
second computer-readable program code for causing the computing apparatus to be attentive to receipt of a selection made via the GUI, the selection being indicative of a desire to forfeit a prospective credit of a non-monetary reward for having purchased the selected flight;
third computer-readable program code for causing the computing apparatus to determine a monetary rebate associated with the non-monetary reward;
fourth computer-readable program code for causing the computing apparatus to determine a purchase price based on (i) a core price for the selected flight and (ii) the monetary rebate;
fifth computer-readable program code for causing the computing apparatus to book the selected flight in response to receipt of a confirmation made via the GUI of an intent to purchase the selected flight at the purchase price.

47. A method to enable a user of a computer-implemented graphical user interface (GUI) to purchase air travel services, comprising:
receiving an indication of a selected flight and a selected service level for the selected flight, as submitted via the GUI;
causing a set of at least one service attribute to be displayed via the GUI, the at least one service attribute being included with flights at a service level higher than the selected service level and not included with flights at the selected service level;
receiving a selection made via the GUI, the selection being indicative of zero or more selected service attributes from the set of at least one service attribute;
determining a purchase price for the selected flight based on the selected service level and the zero or more selected service attributes;
causing the purchase price to be displayed via the GUI; and
causing the selected flight to be booked in response to receipt of a confirmation made via the GUI of an intent to purchase the selected flight at the purchase price.

48. A computer-readable medium comprising computer-readable program code which, when interpreted by a computing apparatus, causes the computing apparatus to execute a method to enable a user of a computer-implemented graphical user interface (GUI) to purchase air travel services, the computer-readable program code comprising:
first computer-readable program code for causing the computing apparatus to be attentive to receipt of an indication of a selected flight and a selected service level for the selected flight, as submitted via the GUI;
second computer-readable program code for causing the computing apparatus to cause a set of at least one service attribute to be displayed via the GUI, the at least one service attribute being included with flights at a service level higher than the selected service level and not included with flights at the selected service level;
third computer-readable program code for causing the computing apparatus to be attentive to receipt of a selection made via the GUI, the selection being indicative of zero or more selected service attributes from the set of at least one service attribute;
fourth computer-readable program code for causing the computing apparatus to determine a purchase price for the selected flight based on the selected service level and the zero or more selected service attributes;
fifth computer-readable program code for causing the computing apparatus to cause the purchase price to be displayed via the GUI; and
sixth computer-readable program code for causing the computing apparatus to cause the selected flight to be booked in response to receipt of a confirmation made via the GUI of an intent to purchase the selected flight at the purchase price.

49. An air travel services architecture, comprising
a computing apparatus implementing a graphical user interface (GUI) that enables a user thereof to purchase air travel services;
a server communicatively coupled to the computing apparatus over a network, the server being configured for:
receiving an indication of a selected flight and a selected service level for the selected flight, as submitted via the GUI;
causing a set of at least one service attribute to be displayed via the GUI, the at least one service attribute being included with flights at a service level higher than the selected service level and not included with flights at the selected service level;
receiving a selection made via the GUI, the selection being indicative of zero or more selected service attributes from the set of at least one service attribute;
determining a purchase price for the selected flight based on the selected service level and the zero or more selected service attributes;
causing the purchase price to be displayed via the GUI; and
causing the selected flight to be booked in response to receipt of a confirmation made via the GUI of an intent to purchase the selected flight at the purchase price.
